(19) United States
(12) Patent Application Publication
(10) Pub. No.: US 2020/0086353 A1
(43) Pub. Date: Mar. 19, 2020

(54) SEED SORTER

(71) Applicant: Monsanto Technology LLC, St. Louis, MO (US)

(72) Inventors: Jennifer L. Becker, Muscatine, IA (US); Eric Borrowman, St. Peters, MO (US); Jarrett R. Ceglinski, St. Louis, MO (US); Govind Chaudhary, Maryland Heights, MO (US); Kevin L. Deppermann, St Charles, MO (US); Xiaofei Fan, Chesterfield, MO (US); Jeffrey L. Kohne, Kirkwood, MO (US); Brad D. White, Creve Coeur, MO (US); Chi Zhang, San Jose, CA (US)

(21) Appl. No.: 16/496,883

(22) PCT Filed: Mar. 21, 2018
(86) PCT No.: PCT/US2018/023528

§ 371 Date: Sep. 23, 2019

Related U.S. Application Data
(60) Provisional application No. 62/474,389, filed on Mar. 21, 2017.

(51) Int. Cl. B07C 5/342; B07C 5/04; G06T 7/60

(52) U.S. Cl. CPC B07C 5/3425; B07C 5/04; B07C 5/361; B07C 2501/0081; G06T 7/60

(57) ABSTRACT

A seed sorting system for sorting seeds includes a seed transfer station configured to move seeds through the system. An imaging assembly includes a 2D camera configured to acquire 2D images of the seeds as the seeds move through the system and a 3D camera configured to acquire 3D images of the seeds as the seeds move through the system. A sorting assembly is configured to sort the seeds into separate bins based on the acquired 2D and 3D images of the seeds.

### FIELD

The present disclosure generally relates to a system and method for processing seeds, and more specifically, a seed sorting system and method for sorting seeds based on characteristics of the seed.

### BACKGROUND

In the agricultural industry, and more specifically in the seed breeding industry, it is important for scientists to be able to analyze seeds with high throughput. By this it is meant that the analysis of the seeds preferably occurs not only quickly, but also reliably and with high total volume. Historically, seeds are sorted by size using mechanical equipment containing screens with holes corresponding to predetermined sizes. Seed sorting is also conducted using image analysis of the seeds to detect certain appearance characteristics of the seeds. However, prior image analysis seed sorting systems are limited in their ability to detect the size, shape, and appearance of the seeds.

### SUMMARY

In one aspect, a seed sorting system for sorting seeds generally comprises a seed transfer station configured to move seeds through the system. An imaging assembly comprises a 2D camera configured to acquire 2D images of the seeds as the seeds move through the system and a 3D camera configured to acquire 3D images of the seeds as the seeds move through the system. A sorting assembly is configured to sort the seeds into separate bins based on the acquired 2D and 3D images of the seeds.

In another aspect, a method of sorting seeds generally comprises moving seeds through the system using a seed transfer station. Acquiring, using a 2D camera, 2D images of the seeds as the seeds move through the system via the seed transfer station. Acquiring, using a 3D camera, 3D images of the seeds as the seeds move through the system via the seed transfer station. Analyzing the 2D and 3D images to determine a parameter of each of the seeds. Sorting, using a sorting assembly, the seeds based on determined parameters of the seeds.

### BRIEF DESCRIPTION OF THE DRAWING

The patent or application file contains at least one drawing executed in color. Copies of this patent or patent application publication with color drawing(s) will be provided by the Office upon request and payment of the necessary fee.

FIG. 1 is block diagram of an automated seed sorter system;

FIG. 2 is a front perspective of the seed sorter system with portions of a sorting assembly removed to show internal detail;

FIG. 3 is a rear perspective of the seed sorter system;

FIG. 4 is a fragmentary perspective of the seed sorter system;

FIG. 5 is a schematic illustration of a side view of the seed sorter system;

FIG. 5A is a schematic illustration of a top view of the seed sorter system;

FIG. 5B is a schematic illustration of a valve bank of the seed sorter system;

FIG. 6A is an image obtained by a 2D camera of the seed sorter system;

FIG. 6B is an image obtained by a 3D camera of the seed sorter system; and

FIG. 6C is surface profile produced from the image in FIG. 6B.

Corresponding reference characters indicate corresponding parts throughout the drawings.

### DETAILED DESCRIPTION

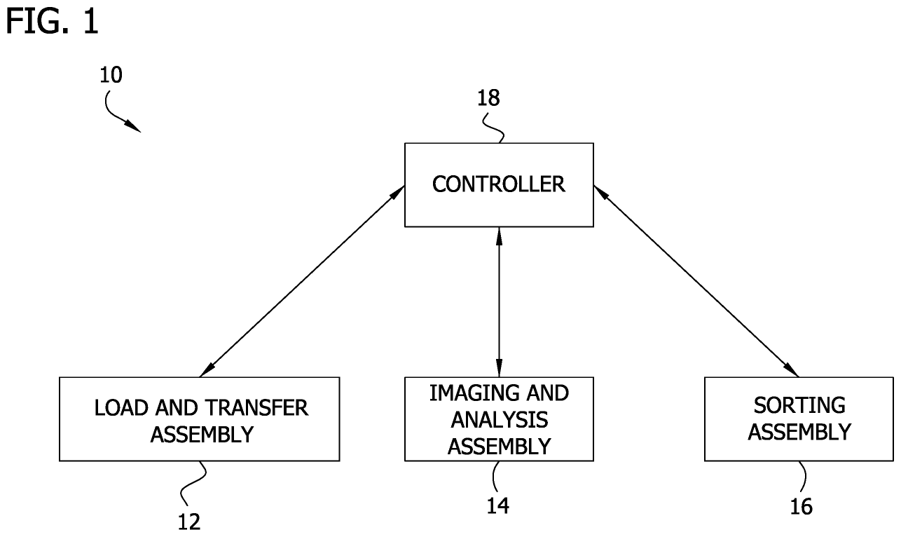

Referring to FIGS. 1-5, a seed sorting system is indicated generally at 10. The system is configured to receive, analyze, and sort a plurality of seeds into selected categories for later processing, assessment, or analysis. The system 10 comprises a load and transfer assembly 12 configured to receive and deliver the seeds through the system, an imaging and analysis assembly 14 for collecting image data of the seeds as they are delivered through the system by the load and transfer assembly, and a sorting assembly 16 configured to sort the seeds into selected categories based on the image data collected for the seeds by the imaging and analysis assembly. A controller 18 (e.g., a processor and suitable memory) is programmed to operate the system 10. The imaging and analysis assembly 14 acquires 3-dimensional image data and incorporates optimized image analysis algorithms for providing rapid and highly accurate size and shape measurements of the seeds. The sorting assembly 16 is configured to sort the seeds into two or more selected categories so that the seeds can be more precisely categorized for later processing, assessment, or analysis. The imaging and analysis assembly 14 and the sorting assembly 16 allow the system to provide high throughput measurement of the seeds to meet real time seed sorting requirements. As such, the system 10 can be implemented into an existing seed processing system and quickly and seamlessly provide a seed sorting function.

Referring to FIGS. 1-3 and 5, the load and transfer assembly 12 comprises a hopper (broadly, a seed loading station) 20 including an inlet 22 for receiving the seeds into the hopper and an outlet 24 for dispensing the seeds from the hopper, and a conveyor 26 (broadly, a seed transfer station) at the outlet of the hopper. In the illustrated embodiment, the conveyor 26 comprises a belt 28 defining a flat horizontal conveyor transport surface. The conveyor 26 provides a flat surface for the seeds to rest as they are delivered through the system 10. As a result, the system 10 is able to better control the travel of each seed through the system and therefore better track the position of the seeds as they move on the conveyor 26 because the seeds will remain in a substantially fixed orientation and position on the conveyor. In one embodiment, a high precision encoder (not shown) is incorporated into the system 10 to track the position of the seeds on the conveyor 26. As will be explained in greater detail below, the flat surface allows for more accurate measurements to be acquired by the imaging and analysis assembly 14. Moreover, the projectile motion of the seeds as they are expelled off an end of the conveyor 26 provides a predictable flight pattern of each seed which can be used to sort the seeds as will be explained in greater detail below.

The conveyor 26 may be a high-speed conveyor capable of operating at speeds of up to about 30 in/sec and above. For example, the conveyor 26 can be operated at up to about 60 in/sec. Depending on the size of the outlet 24 of the hopper 20, the conveyor 26 can deliver the seeds through the system 10 at a rate of about 20 to 250 seeds/sec. However, other seed rates are envisioned. For example feed rates of up to 2000 seeds/second are envisioned. Feed rates of higher than 2000 seeds/second are also envisioned. In one embodiment, the conveyor 26 is blue. The color blue has been found to provide a desired background contrast for obtaining clear images of the seeds. For example, the blue background has been found to provide a desired contract with the yellow color of the seeds. However, the conveyor can be other colors without departing from the scope of the disclosure.

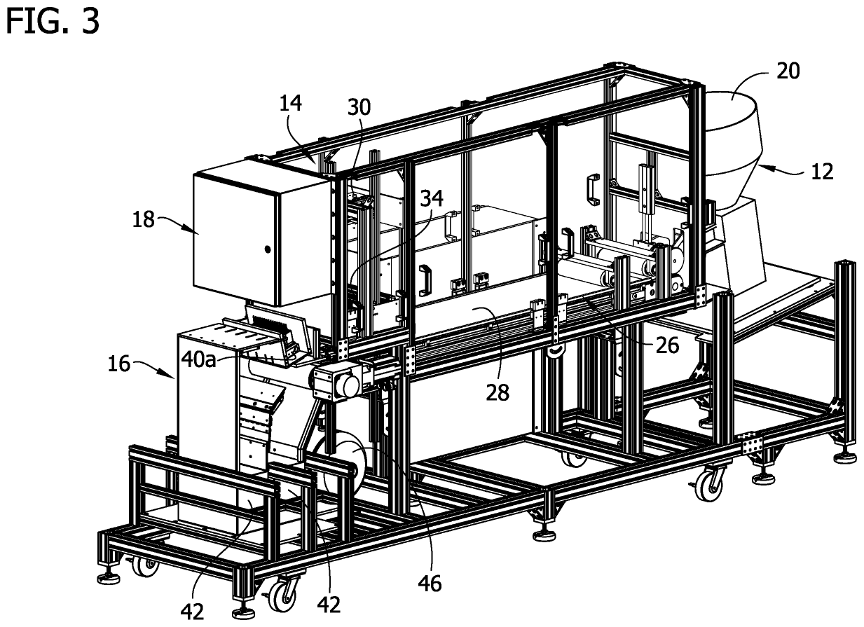

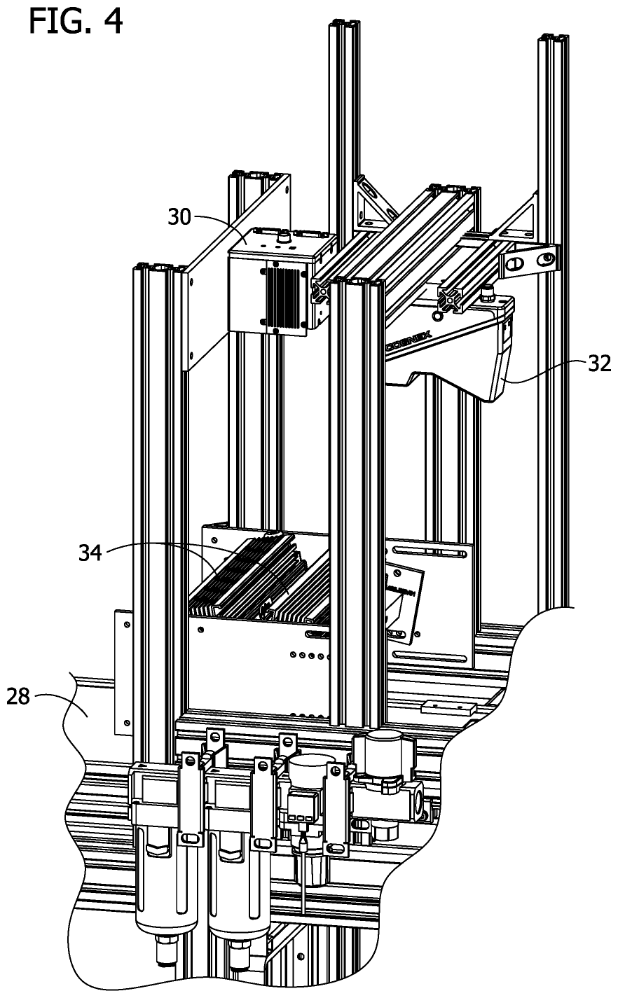

Referring to FIGS. 3-5A, the imaging and analysis assembly 14 comprises an imaging assembly including a 2D line scan RBG camera (broadly, a 2D camera) 30 and a 3D line laser profiler (broadly, a 3D camera) 32 mounted above the conveyor 26 for acquiring image data of the seeds to measure the size and shape of the seeds in three dimensions. The imaging and analysis assembly 14 also includes a processor and memory for processing (i.e., analyzing) the image data, although in other embodiments the controller 18 may be used for such processing. The imaging and analysis assembly 14 can obtain length, width, and thickness (or roundness) dimensions for the seeds. Additionally, a light source 34 (FIG. 4) may be mounted above the conveyor 26 for illuminating the fields of view of the cameras 30, 32 to assist in producing clear and bright images. In one embodiment, the 2D camera 30 is mounted above the conveyor 26 in a substantially vertically orientation such that a focal axis of the 2D camera extends perpendicular to a horizontal plane of the conveyor, and the 3D camera 32 is mounted above the conveyor at an angle skewed from vertical such that a focal axis of the 3D camera extends at a non-orthogonal angle to the plane of the conveyor. With the 2D camera 30 pointed directly downward, the major and minor axes of the 2D camera image are interpreted as length and width dimensions, respectively. Therefore, as the seeds pass through the focal window of the 2D camera 30, length and width dimensions of each seed are recorded. The pixels of the 2D camera 30 may be calibrated for true x-y dimensions. It is envisioned that the 2D camera 30 could be oriented such that the major and minor axes define width and length dimensions, respectively, without departing from the scope of the disclosure. In one embodiment, the shortest and longest axes define the width and length dimensions. This axis interpretation assumes that the seed is lying on its side such that the length of the seeds extends along the conveyor surface. However, it the seed is standing upright, the system automatically adjusts to ensure the height, width, and thickness measurements are recorded correctly.

The 3D camera 32 uses a laser triangulation technique to projects a line laser to create a line profile of the seed's surface. The 3D camera 32 measures the line profile to determine displacement which is represented by an image of the seed showing varying pixel intensities. A thickness dimension of the seeds is obtained through the pixel intensity of the 3D image produced by the 3D camera 32. For example, a maximum pixel intensity can be interpreted as a marker of seed thickness. Thus, as the seeds pass through the focal window of the 3D camera 32, a thickness of each seed is recorded as the maximum pixel intensity detected by the 3D camera for each seed. To acquire an accurate thickness measurement, it may be necessary to calibrate the image intensity of the 3D camera 32 based on the distance the 3D camera is spaced from the surface of the conveyor 26. Using the length and width dimensions acquired from the 2D camera 30 and the thickness dimensions acquired from the 3D camera 32, the system 10 can obtain volume estimates for each seed. In another embodiment, more sophisticated image processing may be used to estimate volume from a detailed contour map of the top half of each seed. For a known or estimated weight of the seed, the volume data can be used to estimate seed density. One example of a suitable 2D camera is the CV-L107CL model by JAI. One example of a suitable 3D camera is the DS1101R model by Cognex. In another embodiment, a different 3D measurement technique such as Time-of-Flight cameras, Stereo Imaging, Light field technique, and others can be used in place of or together with the laser profiler to get the 3D measurements of the seed.

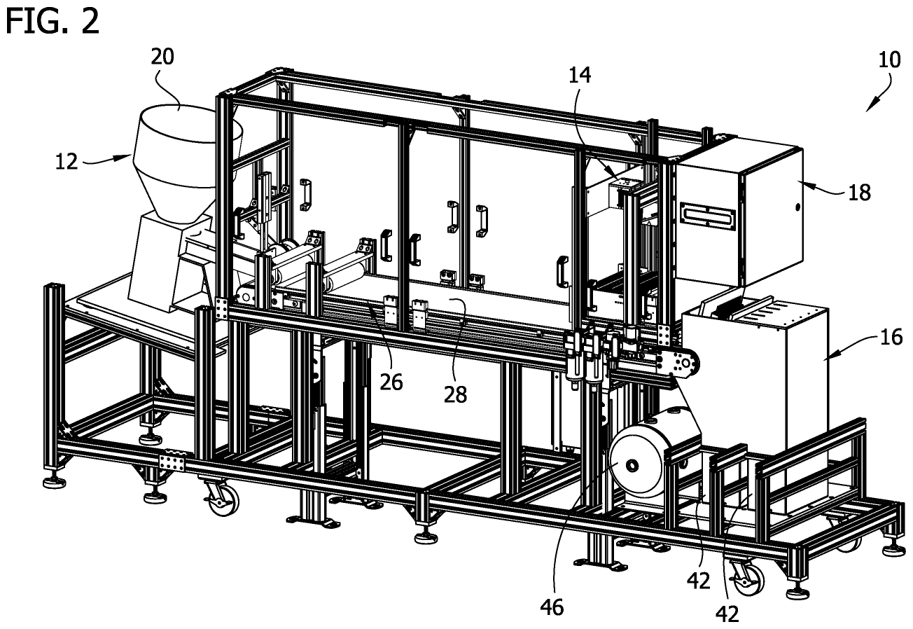

Referring to FIGS. 2, 3, and 5-5B, the sorting assembly 16 comprises a plurality of high speed air valve banks 40 and a plurality of sorting bins 42 located at an end of the conveyor 26 for sorting the seeds into at least two different categories based on the measurements obtained by the imaging and analysis assembly 14. Each valve bank 40 includes multiple air valves 44 in fluid communication with an air compressor 46 for producing burst of air directed at the seeds as they are expelled from the conveyor 26. The air is used to redirect the flight of the seeds so that the seeds land in a selected sorting bin 42 corresponding to the characteristics of the seeds identified by the imaging and analysis assembly 14. As previously mentioned, the seeds are tracked by a high precision encoder (not shown). Thus, the system 10 can monitor the path of the seeds and predict when and where the seeds will be expelled from the conveyor 26. Therefore, the system 10 can predict the location and flight of each seed as it leaves the conveyor 26. This information is used by the controller 18 to instruct the operation of the valves 44 in the valve banks 40. In one embodiment, each valve bank 40 includes thirty two (32) air valves 44. However, a different number or air valves is envisioned without departing from the scope of the disclosure. The array of valves 44 is provided in an adequate number and arrangement to locate the valves in position to accommodate the random placement of the seeds on the conveyor.

In the illustrated embodiment, there are two (2) valve banks 40 selectively positioned for sorting the seeds into three (3) sorting bins 42. A first sorting bin 42a is located closest to the conveyor 26, a second sorting bin 42b is located next to the first sorting bin and located farther from the conveyor than the first sorting bin, and a third sorting bin 42c is located next to the second sorting bin and spaced farther from the conveyor than the second sorting bin. Thus, the second sorting bin 42b is located between the first and third sorting bins 42a, 42c. A first valve bank 40a is disposed generally over the first sorting bin 42a and directed downward such that the bursts of air from the valves 44 in the first valve bank create a downward diverting force along a substantially vertical axis. This downward diverting force can redirect the path of a seed as it leaves the conveyor 26 so that the seed falls into the first sorting bin 42. A second valve bank 40b is disposed in the second sorting bin 42b and directed upward at an angle toward the third sorting bin 42c. Therefore, the bursts of air produced by the valves in the second valve bank 40b create an upward diverting force along an angled axis so that seeds leaving the conveyor 26 can be diverted away from the second sorting bin 42b and into the third sorting bin 42c. Thus, if a seed is not redirected by either of the valve banks 40a, 40b, the seed will land in the second valve bin 42b as a result of the natural trajectory of the seed leaving the conveyor 26. It will be understood that the conveyor 26 can be operated and/or the sorting bins 42 can be positioned so that the natural flight of the seeds will land the seeds in either the first or third sorting bin 42a, 42c.

In the illustrated embodiment, the second valve bank 40b is angled at a 45 degree angle. However, the second valve bank 40b could be oriented at a different angle without departing from the scope of the disclosure. Also, it will be understood that the valve banks 40a, 40b could be located in different positions to redirect the seeds along different paths. For example, in one embodiment, a natural trajectory of the seeds may cause them to fall into the first sorting bin 42a. In this instance, a valve bank may be located in the first sorting bin to redirect the seeds into the second sorting bin. Moreover, additional valve banks could be used for sorting the seeds into more than three bins. In this embodiment, each valve bank would direct the seeds into a specific bin. For example, a first valve bank would direct the seeds into the first sorting bin 42a, a second valve bank would be positioned to direct the seeds into the second sorting bin 42b, and a third valve bank would be positioned to direct the seeds into the third sorting bin 42c. The seeds natural trajectory would carry them to a fourth sorting bin (not shown) when not disturbed by air from any of the valves.

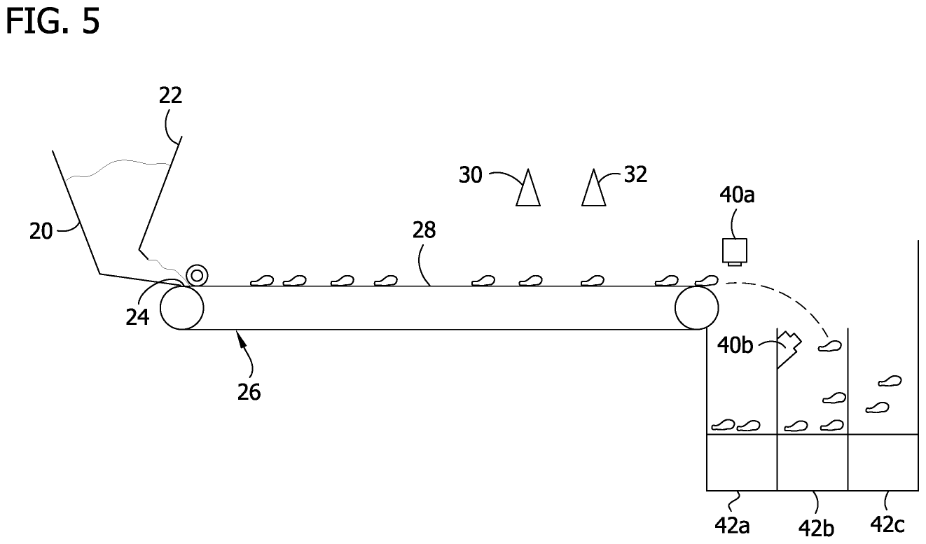

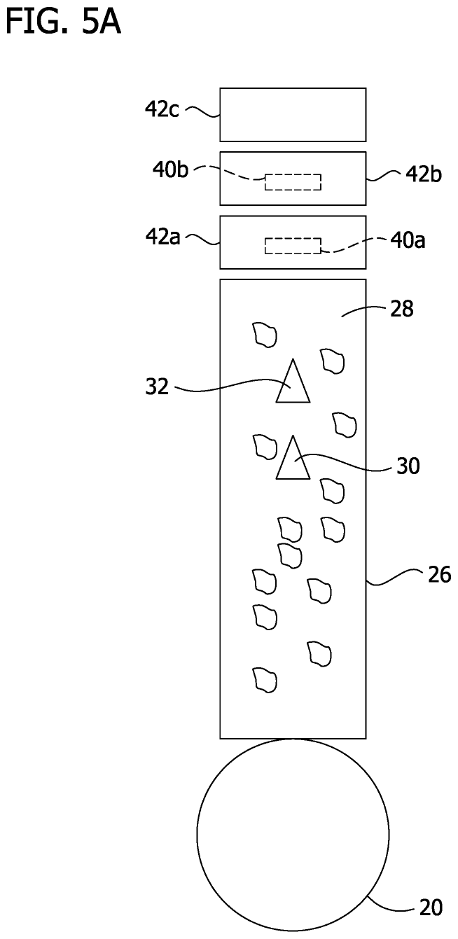

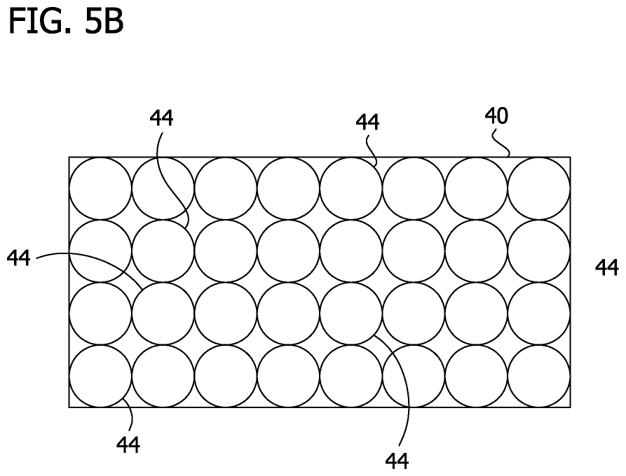

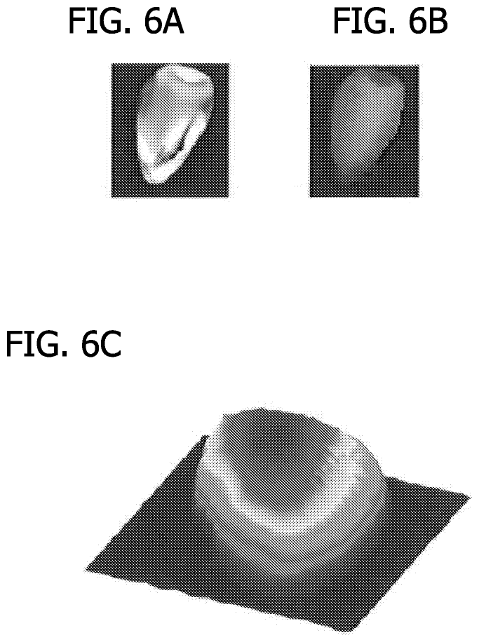

Referring to FIG. 5, seeds are first placed in the hopper 20 in preparation of being transported by the conveyor 26 through the system 10. As the seeds leave the outlet 24 of the hopper 20, the conveyor carries the seeds into view of the 2D camera 30 and 3D camera 32. Because the seeds travel along the flat, blue conveyor 26, clear image data are acquired. Additionally, the seeds remain in a known location and fixed orientation which allows each seed to be tracked with a high level of accuracy by the precision encoder. The seeds first pass under the focal view of the 2D camera 30. The 2D camera 30 acquires a 2-dimensional image of each seed which is processed by the controller 18 to produce length and width data for each seed. In one embodiment, the value associated with a maximum length and width measurements are recorded as the length and width values for the seed. FIG. 6A shows a representative image acquired by the 2D camera 30. An encoder reading is also recorded as the seed is imaged by the 2D camera 30 to track the position of the seed on the conveyor 26.

The seeds continue to travel along the conveyor 26 until the seeds pass under the focal view of the 3D camera. 32. The 3D camera 32 acquires a 3-dimensional image of each seed which is processed by the controller 18 to produce thickness data for each seed. FIG. 6B shows a representative image acquired by the 3D camera 32. Using the 3D image, the controller 18 produces the surface profile shown in FIG. 6C. The different colors of the surface profile indicate thickness. In the illustrated embodiment, the thickness increases from blue to red. Analysis of the surface profile provides a thickness measurement for a given seed. In one embodiment, the value associated with the thickest region is recorded as the thickness value for the seed. An encoder reading is also recorded as the seed is imaged by the 3D camera 32 to track the position of the seed on the conveyor 26. It will be understood that the analysis of the surface profile can also provide information regarding seed volume and mechanical seed damage.

Based on the length and width data from the 2D camera 30, and the thickness data from the 3D camera 32, the controller 18 can identify and categorize each seed according to its size. For example, predetermined size categories may be stored in the controller 18. The size categories may be based on dimension thresholds for each of the length, width, and thickness data. Based on these thresholds, at least two categories can be defined. Each sorting bin 42 is representative of a category. Thus, in the illustrated embodiment, three categories are defined. As each seed is analyzed the seed is associated with one of the categories. For example, a seed having one or more dimensions that exceed a threshold valve are categorized into a first category, and seeds having one or more dimensions that are within a threshold valve are categorized into a second category. Multiple threshold values may be established to further categorize the seeds into more than two categories. Once the seed reaches the end of the conveyor 26, the valve banks 40 are operated by the controller 18 to divert the seed into the bin 42 associated with its designated category.

The information obtained using the imaging and analysis assembly 14 can useful in the subsequent processing, assessment, or analysis of the seeds. For example, in seed production plants, the data generated by the system 10 can be used to predict an overall distribution of seeds of different size and shapes in a seed inventory, and to determine size and shape distribution of a sub sample of seeds which can then be extrapolated to predict the overall seed inventory status. This distribution information may also be used to adjust sizing thresholds slightly in cases where seed quantities are limited in some size categories. The sorted seeds can also be used in seed quality labs for assessing seed quality for each size and shape category.

Additionally, even without the sorting assembly 16, the imaging assembly 14 provides useful information by collecting the real time distribution of seed sizes in a flow of seeds. In this case, the entire flow of seeds can be measured, or a “slip stream” that is a statistically valid subset of the total flow can be measured to determine the size makeup of the flow.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

1. A seed sorting system for sorting seeds, the system comprising:
a seed transfer station configured to move seeds through the system;
an imaging assembly comprising a 2D camera configured to acquire 2D images of the seeds as the seeds move through the system and a 3D camera configured to acquire 3D images of the seeds as the seeds move through the system; and
a sorting assembly configured to sort the seeds into separate bins based on the acquired 2D and 3D images of the seeds.

2. The seed sorting system of claim 1, further comprising a controller configured to determine length and width dimensions of the seeds from the acquired 2D images and thickness dimensions of the seeds from the acquired 3D images, wherein the controller is configured to control the sorting assembly to sort the seeds based on the determined length and width dimensions of the seeds from the acquired 2D images and the determined thickness dimensions of the seeds from the acquired 3D images.

3. (canceled)

4. The seed sorting system of claim 2, wherein the controller is configured to produce a surface profile of each of the 3D images, the controller configured to measure a pixel intensity of the surface profile to determine the thickness dimension.

5. The seed sorting system of claim 1, wherein the 2D camera has a focal axis extending in a substantially vertical direction.

6. The seed sorting system of claim 5, wherein the 3D camera has a focal axis extending in a direction skewed from vertical.

7. The seed sorting system of claim 6, wherein the seed transfer station comprises a conveyor including a belt configured to transport the seeds in a substantially horizontal direction.

8. (canceled)

9. The seed sorting system of claim 7, wherein the conveyor is blue.

10. The seed sorting system of claim 1, wherein the sorting assembly comprises a plurality of valve banks and a plurality of sorting bins, the valve banks being operable by the controller to sort the seeds into the sorting bins as the seeds leave the seed transfer station.

11. The seed sorting system of claim 10, wherein the sorting assembly comprises at least two valve banks and at least three sorting bins, and wherein a first valve bank is mounted over a first sorting bin and is directed downward in a substantially vertical orientation, and the second valve bank is mounted in a second sorting bin and is directed upward at an angle toward a third sorting bin.

12. (canceled)

13. The seed sorting system of claim 11, wherein the seed transfer station is configured to direct seeds into the second sorting bin, the first valve bank being operable to direct seeds away from the second sorting bin and into the first sorting bin, and the second valve bank being operable to direct seeds away from the second sorting bin and into the third sorting bin.

14. A method of sorting seeds, the method comprising:
moving seeds through the system using a seed transfer station;
acquiring, using a 2D camera, 2D images of the seeds as the seeds move through the system via the seed transfer station;
acquiring, using a 3D camera, 3D images of the seeds as the seeds move through the system via the seed transfer station;
analyzing the 2D and 3D images to determine a parameter of each of the seeds; and
sorting, using a sorting assembly, the seeds based on determined parameters of the seeds.

15. The method of claim 14, wherein analyzing the 2D and 3D images comprises:
determining, using a controller, length and width dimensions of the seeds from the acquired 2D images;
determining, using the controller, thickness dimensions of the seeds from the acquired 3D images; and
categorizing, using the controller, each of the seeds based on the determined parameter of the seed.

16. (canceled)

17. The method of claim 15, further comprising producing, using the controller, a surface profile of the 3D images and measuring, using the controller, a pixel intensity of the surface profile to determine the thickness dimensions.

18. The method of claim 17, further comprising measuring, using the controller, volume and seed damage from the acquired 3D images.

19. The method of claim 14, wherein said moving the seeds through the system comprises moving the seeds via a conveyor in a substantially horizontal direction.

20. The method of claim 19, wherein said moving the seeds through the system comprises operating the conveyor at a speed of at least about 30 in/sec.

21. The method of claim 20, wherein said moving the seeds through the system comprises operating the conveyor at a speed of at least about 60 in/sec.

22. The method of claim 21, wherein said moving the seeds through the system comprises operating the conveyor at a speed of at least about 200 in/sec.

23. The method of claim 14, wherein said sorting the seeds comprises sorting the seeds into at least three separate sorting bins.

24. The method of claim 23, wherein said sorting the seeds comprises operating at least two valve banks to sort the seeds into the at least three sorting bins.
